(19) United States
(12) Patent Application Publication
(10) Pub. No.: US 2026/0059163 A1
(43) Pub. Date: Feb. 26, 2026

(54) METHOD, APPARATUS, DEVICE AND STORAGE MEDIUM FOR LIVE STREAMING INTERACTION

(71) Applicant: Beijing Zitiao Network Technology Co., Ltd., Beijing (CN)

(72) Inventors: Xin Cai, Beijing (CN); Zhihao Xu, Beijing (CN); Zhenghao Guan, Beijing (CN)

(21) Appl. No.: 19/303,648

(22) Filed: Aug. 19, 2025

(30) Foreign Application Priority Data
Aug. 20, 2024 (CN) 202411147549.3

(51) Int. Cl. H04N 21/431; G06F 3/04883; H04N 21/2187; H04N 21/485

(52) U.S. Cl. CPC H04N 21/431; G06F 3/04883; H04N 21/2187; H04N 21/4854

(57) ABSTRACT

A method, apparatus, device and storage medium for live streaming interaction are provided. The method includes: receiving, in a live streaming interface of a live streaming room, a request for using an interactive resource; rendering, in response to receiving a swipe operation, a first graphical element in the live streaming interface based on a first set of coordinate points corresponding to the swipe operation, the first graphical element including a plurality of map elements corresponding to the interactive resource; smoothing, in response to ending of the swipe operation, the first set of coordinate points to determine a second set of coordinate points; and rendering a second graphical element in the live streaming interface based on the second set of coordinate points, where the rendered first graphical element and the rendered second graphical element are provided to generate a live streaming image of the live streaming room.

### CROSS-REFERENCE

This application claims the priority of Chinese Patent Application No. 202411147549.3, entitled “METHOD, APPARATUS, DEVICE AND STORAGE MEDIUM FOR LIVE STREAMING INTERACTION,” filed on Aug. 20, 2024, the entire content of which is incorporated herein by reference.

### FIELD

Example embodiments of the present disclosure generally relate to the field of computers, and in particular, to a method, apparatus, device and computer-readable storage medium for live streaming interaction.

### BACKGROUND

With the development of computer technologies, live streaming has become an important way for people to obtain and share information. The interactivity of traditional live content is relatively low, usually limited to text chat or simple gift giving. It is desirable to be able to enrich the form of interactions in live scenes.

### SUMMARY

In a first aspect of the present disclosure, a method of live streaming interaction is provided. The method includes: receiving, in a live streaming interface of a live streaming room, a request for using an interactive resource; rendering, in response to receiving a swipe operation, a first graphical element in the live streaming interface based on a first set of coordinate points corresponding to the swipe operation, the first graphical element including a plurality of map elements corresponding to the interactive resource; smoothing, in response to ending of the swipe operation, the first set of coordinate points to determine a second set of coordinate points; and rendering a second graphical element in the live streaming interface based on the second set of coordinate points, where the rendered first graphical element and the rendered second graphical element are provided to generate a live streaming image of the live streaming room.

In a second aspect of the present disclosure, an apparatus for live streaming interaction is provided. The apparatus includes: a request receiving module configured to receive, in a live streaming interface of a live streaming room, a request for using an interactive resource; a first rendering module configured to render, in response to receiving a swipe operation, a first graphical element in the live streaming interface based on a first set of coordinate points corresponding to the swipe operation, the first graphical element including a plurality of map elements corresponding to the interactive resource; a coordinate smoothing module configured to smooth, in response to ending of the swipe operation, the first set of coordinate points to determine a second set of coordinate points; and a second rendering module configured to render a second graphical element in the live streaming interface based on the second set of coordinate points, where the rendered first graphical element and the rendered second graphical element are provided to generate a live streaming image of the live streaming room.

In a third aspect of the present disclosure, an electronic device is provided. The device includes at least one processor; and at least one memory coupled to the at least one processor and storing instructions for execution by the at least one processor, the instructions, when executed by the at least one processor, causing the electronic device to perform the method of the first aspect.

In a fourth aspect of the present disclosure, a computer-readable storage medium is provided. The computer-readable storage medium has a computer program stored thereon, the computer program, when executed by a processor, implementing the method of the first aspect.

It would be appreciated that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, where:

FIG. 1 illustrates a schematic diagram of an example environment in which embodiments of the present disclosure can be implemented;

FIGS. 2A to 2C illustrate schematic diagrams of example interfaces according to some embodiments of the present disclosure;

FIG. 3 shows an example flowchart of drawing a graphic element according to some embodiments of the present disclosure;

FIG. 4 shows a flowchart of an example process for live streaming interaction according to some embodiments of the present disclosure;

FIG. 5 illustrates a block diagram of an apparatus for live streaming interaction according to some embodiments of the present disclosure; and

FIG. 6 illustrates a block diagram of an electronic device capable of implementing various embodiments of the present disclosure.

### DETAILED DESCRIPTION

It would be appreciated that, before the technical solutions disclosed in the embodiments of the present disclosure are used, the types of personal information related to the present disclosure, the usage scope, the usage scenario and the like would be notified to the user in an appropriate manner according to the relevant laws and regulations and obtain the authorization of the user.

For example, in response to receiving an active request from a user, prompt information is sent to the user to explicitly prompt the user that the requested operation will need to acquire and use the personal information of the user. Therefore, the user may autonomously select whether to provide personal information to software or hardware executing the operation of the technical solution of the present disclosure according to the prompt information.

As an optional but non-limiting implementation, in response to receiving the active request of the user, the manner of sending the prompt information to the user may be, for example, a pop-up window, and the prompt information may be presented in a text manner in the pop-up window. In addition, the pop-up window may further carry a selection control for the user to select “agree” or “disagree” to provide personal information to the electronic device.

It would be appreciated that the foregoing notification and obtaining a user authorization process is merely illustrative, and does not constitute a limitation on implementations of the present disclosure, and other manners of meeting related laws and regulations may also be applied to implementations of the present disclosure.

It would be appreciated that the data involved in the technical solution (including but not limited to the data itself, the obtaining or use of the data) would follow the requirements of the corresponding laws and regulations and related regulations.

The term “in response to” as used herein represents the state in which the corresponding event occurs, or condition is fulfilled. It would be appreciated that there may not be a strong correlation between the timing of the execution of a subsequent action that is performed in response to the event or condition and the time when the event or condition occurs or is established. For example, in some cases, the subsequent action may be executed immediately upon the occurrence of the event or the establishment of the condition; in other cases, the subsequent action may be executed sometime after the occurrence of the event or the establishment of the condition.

The embodiments of the present disclosure would be described in more detail below with reference to the accompanying drawings. While certain embodiments of the present disclosure are shown in the accompanying drawings, it would be appreciated that the present disclosure may be implemented in various forms, and would not be construed as limited to the embodiments set forth herein, but rather, these embodiments are provided for a more thorough and complete understanding of the present disclosure. It would be appreciated that the drawings and the embodiments of the present disclosure are for example purposes only and are not intended to limit the scope of the present disclosure.

It would be appreciated that the title of any section/subsection provided herein is not limiting. Various embodiments are described throughout, and any type of embodiments may be included in any section/subsection. Furthermore, the embodiments described in any section/subsection may be combined in any manner with the same section/subsection and/or any other embodiment described in different sections/subsections.

In the description of the embodiments of the present disclosure, the terms “including” and the like would be appreciated to include “including but not limited to”. The term “based on” would be appreciated as “based at least in part on”. The terms “one embodiment” or “the embodiment” would be appreciated as “at least one embodiment”. The term “some embodiments” would be appreciated as “at least some embodiments”. Other explicit and implicit definitions may also be included below. The terms “first,” “second,” and the like may refer to different or identical objects. Other explicit and implicit definitions may also be included below.

Existing live streaming scenarios lack a specialized interactive prop for drawing interaction. Although drawing tools exist in non-live streaming scenarios, they often suffer from high performance consumption and are not well adapted to the use of live streaming scenarios. In addition, these tools have a single form of texture expression, which limits the possibility of creative expression in live streaming.

In this regard, embodiments of the present disclosure provide a solution for live streaming interaction. According to various embodiments of the present disclosure, a request for using an interactive resource is received in a live streaming interface of a live streaming room, a first graphical element in the live streaming interface is rendered, in response to receiving a swipe operation, based on a first set of coordinate points corresponding to the swipe operation, the first graphical element comprising a plurality of map elements corresponding to the interactive resource; the first set of coordinate points is smoothed, in response to ending of the swipe operation, to determine a second set of coordinate points; and a second graphical element is rendered in the live streaming interface based on the second set of coordinate points, wherein the rendered first graphical element and the rendered second graphical element are provided to generate a live streaming image of the live streaming room.

As a result, the embodiments of the present disclosure significantly enhance the interactivity of the live streaming by implementing a drawing interactive prop in the live streaming scenario. In addition, by providing a brush style corresponding to a plurality of map elements, the embodiments of the present disclosure further enrich the expression of the drawing content.

In addition, by executing rendering processes with different performances at different stages (e.g., during and after swiping), the embodiments of the present disclosure not only reduce the performance consumption of rendering, but also enhance the quality of the created graphic elements.

Example embodiments of the present disclosure are described below with reference to the accompanying drawings.

### Example Environment

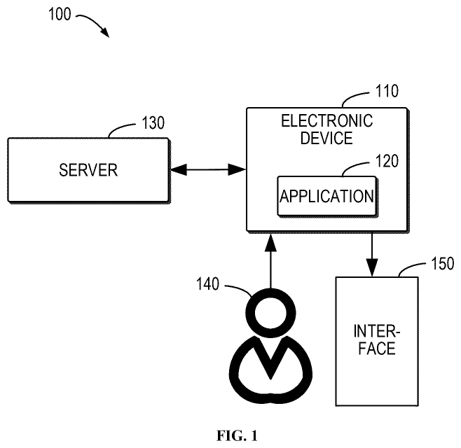

FIG. 1 illustrates a schematic diagram of an example environment 100 in which embodiments of the present disclosure can be implemented. As shown in FIG. 1, the example environment 100 may include an electronic device 110.

In this example environment 100, the electronic device 110 may be run with an application 120 for providing, viewing a media content. The application 120 may be any appropriate type of application for providing, viewing a media content, examples of which may include, but are not limited to: an online video application, a social application, a content sharing application, etc. A user 140 may interact with the application 120 via the electronic device 110 and/or an attached device thereof.

In the environment 100 of FIG. 1, if the application 120 is active, the electronic device 110 may present an interface 150 corresponding to the application 120. The interface 150 may include various pages provided by the application 120, such as a playing page of a media content.

In some embodiments, the electronic device 110 communicates with the server 130 to enable provisioning of services to the application 120. The server 130 may provide functions such as management, configuration, and maintenance for an application or website.

The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 can also support any type of interface for a user (such as a “wearable” circuit, etc.).

The server 130 may be a standalone physical server, a server cluster composed of multiple physical servers, or a distributed system, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, or the like. The server 130 may provide a background service for the application 120 that supports live streaming interactions in the electronic device 110.

A communication connection may be established between the server 130 and the electronic device 110. The communication connection may be established in a wired manner or a wireless manner. The communication connection may include, but is not limited to, a Bluetooth connection, a mobile network connection, a Universal Serial Bus (USB) connection, a Wireless Fidelity (Wi-Fi) connection, and the like, and the embodiments of the present disclosure are not limited in this aspect. In an embodiment of the present disclosure, the server 130 and the electronic device 110 may implement signaling interaction through a communication connection between the server 130 and the electronic device 110.

It would be appreciated that the structures and functions of the various elements in the environment 100 are described for example purposes only and do not imply any limitation to the scope of the present disclosure.

Various example implementations of the present disclosure will be described in detail below.

### Example Drawing Prop

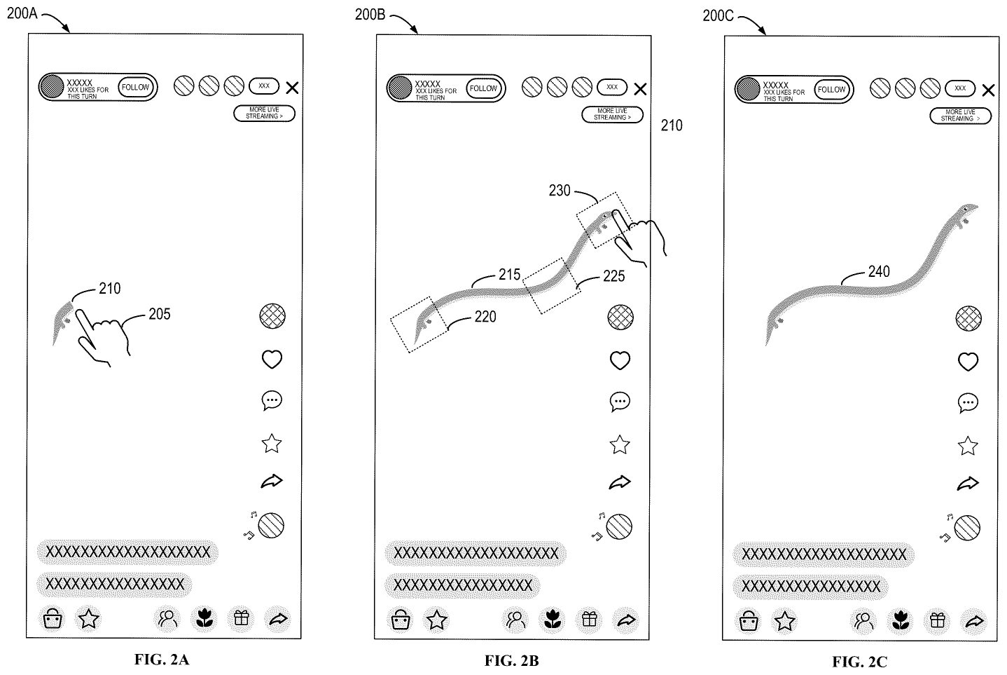

An example live streaming interaction process according to the embodiments of the present disclosure will be described below with reference to FIGS. 2A to 2C. FIGS. 2A to 2C illustrate example live streaming interfaces 200A to 200C according to some embodiments of the present disclosure. The interfaces 200A to 200C may be provided, for example, by the electronic device 110 shown in FIG. 1.

In some embodiments, the interfaces 200A to 200C may correspond to a live streaming party (e.g., an anchor user) of a live streaming room. As will be described in detail below, the electronic device 110 may receive a use request of an anchor user for an interactive resource (for example, a drawing prop), and may add a graphic element corresponding to a touch operation in the live streaming image accordingly.

In some embodiments, the electronic device 110 may, for example, provide a plurality of types of drawing props to the anchor user. In some embodiments, different types of drawing props may, for example, correspond to different brush effects, i.e., styles of map elements corresponding to brush trajectories.

As shown in FIG. 2A, the electronic device 110 may, for example, receive a selection of an animal brush by an anchor user. Further, the electronic device 110 may receive a swipe operation 205 of the anchor user in the live streaming interface 200A.

In some embodiments, the electronic device 110 may determine a corresponding first set of coordinate points (i.e., swiping coordinates) based on the swipe operation 205. Further, the electronic device 110 may render a graphical element 210 based on the first set of coordinate points during the swipe operation 205.

As shown in FIG. 2B, as the swipe operation 205 continues, the graphical element 210 may gradually extend and update to a graphical element 215 (also referred to as a first graphical element).

As shown in FIG. 2B, the graphical element 215 may have an animal style and it may, for example, have a plurality of different map elements. Such plurality of map elements may all correspond to a selected drawing tool. For example, different drawing tools may correspond to different styles of map elements.

As an example, the graphic element 215 may include a map element 220 corresponding to a tail (also referred to as a tail map), a map element 225 corresponding to a body (also referred to as a body map), and a map element 230 corresponding to a head (also referred to as a head map).

In some embodiments, the rendered graphical element 210 may be added to the live streaming image of the live streaming room as part of the live streaming image. For example, the electronic device 110 may locally generate a video stream including the graphical element 210 and may send the video stream to the server 130 for other clients of the live streaming room to display the live streaming image including the graphical element 210.

In some embodiments, during the continuation of the swipe operation 205, the electronic device 110 is drawing the graphical element 215 based on the swiping coordinates of the user. However, the swipe of the user may not be sufficiently smooth, thereby affecting the realism of the graphical element 215.

In some embodiments, at the end of the swipe operation 205, the electronic device 110 may also perform a smoothing process on the first set of coordinate points corresponding to the swipe operation 205 (i.e., the swing coordinates) to determine a second set of coordinate points. As will be described in detail below, electronic device 110 may, for example, perform one or more rounds of interpolation calculations to determine the second set of coordinate points.

Further, as shown in FIG. 2C, the electronic device 110 may render a graphical element 240 based on the smoothed second set of coordinate points.

In some embodiments, the rendered graphical element 240 may be added to the live streaming image of the live streaming room as part of the live streaming image. For example, the electronic device 110 may locally generate a video stream that includes the graphic element 240, and may send the video stream to the server 130, so that other clients of the live streaming room display the live streaming image including the graphic element 240.

In this way, by implementing the drawing interaction prop in the live streaming scenario, the interactivity of the live streaming is significantly enhanced. In addition, by providing the brush styles corresponding to the plurality of map elements, the embodiments of the present disclosure further enrich the expression form of the drawing content.

In some embodiments, the electronic device 110 may further provide, for example, one or more edit controls (not shown in the figure) corresponding to the selected interactive resource (for example, a drawing prop).

As an example, the electronic device 110 may, for example, provide a first edit control (also referred to as an erase control) for erasing a most recently added graphical element. Taking FIG. 2C as an example, after receiving a selection of the erase control, the electronic device 110 may cease to display the rendered graphical element 240 in the live streaming interface 200C.

In some embodiments, the electronic device 110 may further provide, for example, a second edit control (also referred to as a clearing control) for clearing all graphical elements corresponding to the selected drawing prop.

Alternatively, in response to a selection of a second edit control associated with the interactive resource in the live streaming interface, the electronic device 110 may cease to display in the live streaming interface a set of graphical elements rendered based on the interactive resource. As an example, after receiving a selection of the clearing control, the electronic device 110 may cease to display all graphic elements rendered based on the drawing prop in the live streaming interface.

In some embodiments, the electronic device 110 may allow a plurality of graphical elements to be created in a live streaming interface. As an example, for the same drawing prop, the electronic device 110 may, for example, set an upper limit of the number of graphical elements allowed to be added. After the upper limit is reached, when receiving a new drawing operation, the electronic device 110 may erase the earliest graphical element rendered based on the drawing prop from the live streaming interface.

In some embodiments, the electronic device 110 may also allow simultaneous rendering of graphical elements authored based on different drawing props in the live streaming interface. As an example, the electronic device 110 may also receive a selection of a further drawing prop (also referred to as a second interactive resource). Further, the electronic device 110 may receive the swipe operation and render the new graphical element based on a third set of coordinate points corresponding to the received swipe operation.

In some examples, the new graphical element may include a plurality of map elements of different types corresponding to the selected drawing prop. For example, a further drawing prop may correspond to a head map, a body map, and a tail map corresponding to a further animal.

Similarly, after the swipe operation ends, the electronic device 110 may perform a smoothing process on the third set of coordinate points, and may render the updated graphic element based on the smoothed coordinate points.

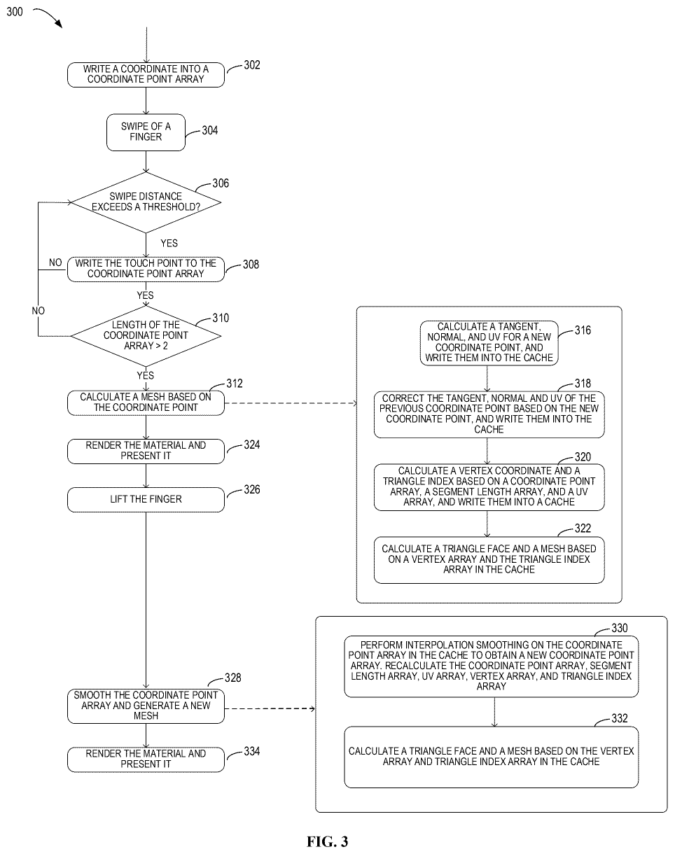

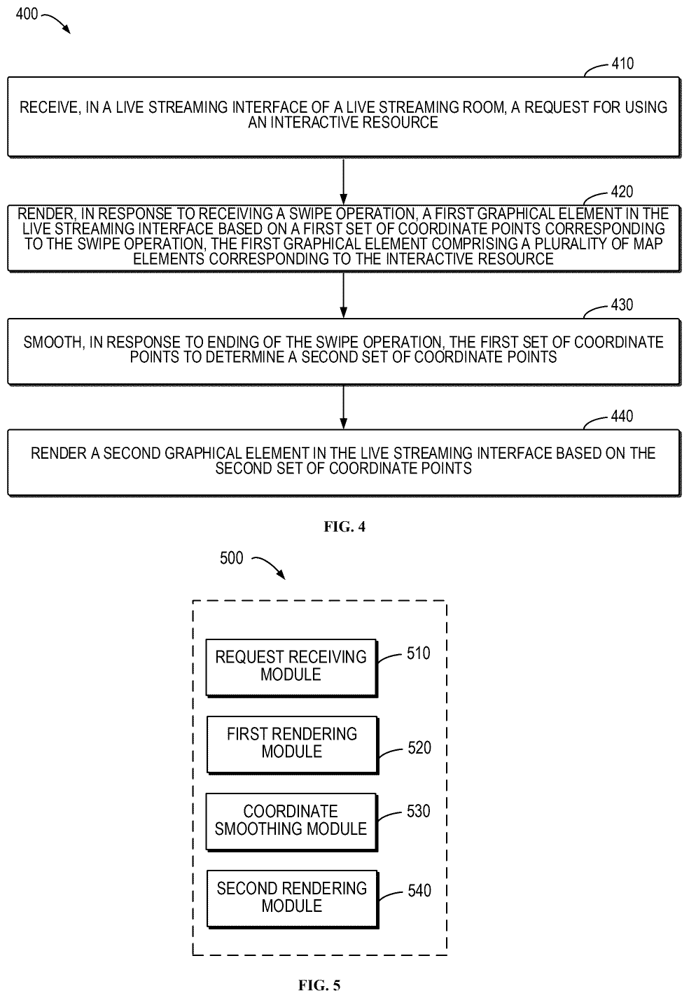

The specific process of rendering the graphic elements will be further described below in conjunction with FIG. 3.

As shown in FIG. 3, at 302, the electronic device 110 may write a start coordinate of a swipe operation into a coordinate point array. At 304, the electronic device 110 may receive a swipe operation of a finger.

At 306, the electronic device 110 may determine whether a distance of the swipe exceeds a threshold. If yes, at 308, the electronic device 110 may write a new touch point to the coordinate point array, and if not, the electronic device 110 may determine whether the threshold is exceeded based on detecting a change in the swipe distance.

At 310, the electronic device 110 may determine if the length of the coordinate point array exceeds 2. If yes, the electronic device 110 may start a first stage of a rendering process. Specifically, at 312, the electronic device 110 may calculate a mesh based on the coordinate points.

As shown in FIG. 3, step 312 may specifically include step 316 to step 320. Specifically, at 316, the electronic device 110 may determine a tangent direction of a new coordinate point based on the coordinate points in the coordinate point array, and may determine a normal direction based on a perpendicular line of the tangent direction. Further, the electronic device 110 may determine a drawing coordinate (for example, a UV coordinate) corresponding to the coordinate point. The above information may be written in a cache, for example.

Further, at 318, the electronic device 110 may modify the tangent, normal, and UV coordinate of the previous coordinate point based on the data of the new coordinate point. For example, in the case of a plurality of coordinate points forming a corner, the electronic device 110 may modify the vertex data and vertex index data of the previous coordinate based on the data of the new coordinate point, thereby improving continuity between the rendering data. The electronic device 110 may write the modified data to a cache.

At 320, the electronic device 110 may compute an array of vertices and a triangulated face index based on a coordinate point array, a segment length array, and a texture coordinate array, and may write the above data to a cache.

At 322, the electronic device 110 may calculate a triangulated face and a mesh based on the vertex information and the index information in the cache.

Specifically, during the process of calculating the mesh, the electronic device 110 may determine a target direction (for example, a tangent direction) corresponding to the target texture coordinate to be rendered. Further, the electronic device 110 may determine a plurality of extended coordinates associated with the target texture coordinate based on the target direction. For example, the electronic device 110 may determine a plurality of extended coordinates corresponding to uv.y=0 and uv.y=1 based on the target texture coordinate and the corresponding normal direction.

Further, the electronic device 110 may determine a mesh corresponding to the target texture coordinate based on the corresponding plurality of extended coordinates.

With continued reference to FIG. 3, at block 324, the electronic device 110 may perform texture rendering and presentation. Specifically, the electronic device 110 may determine a set of texture coordinates (e.g., UV coordinates) corresponding to the first set of coordinate points. Further, the electronic device 110 may determine, based on a distance from a target texture coordinate in the set of texture coordinates to a reference texture coordinate, a target map element corresponding to the target texture coordinate from a set of predetermined map elements.

Specifically, uv.x corresponding to the reference texture coordinate may be 0. Further, if uv.x<0.1 (i.e., a first threshold) corresponding to the texture coordinates, the electronic device 110 may sample the tail map (i.e., a first map element); if 0.01<=uv.x<=0.99 (i.e., a second threshold), the electronic device 110 may sample the body map (i.e., the second map element); if 0.99<uv.x, the electronic device 110 may sample the head map (e.g., a third map element).

Further, the electronic device 110 may render the target map element in the mesh corresponding to the target texture coordinate.

With continued reference to FIG. 3, at 326, the electronic device 110 may detect whether the finger is lifted, that is, detect whether the swipe operation ends.

If the swipe operation ends, the electronic device 110 may perform a smoothing process on the coordinate point array at 328 to generate a new mesh.

Specifically, at 330, the electronic device 110 may perform interpolation smoothing according to the coordinate point array (that is, the first set of coordinate points) in the cache, to determine the second set of coordinate points. Further, the electronic device 110 may recalculate rendering data such as a coordinate point array, a segment length array, a UV array, a Vertex array, and triangulated face index data based on the smoothed second set of coordinate points.

Specifically, during the process of smoothing interpolation, the electronic device 110 may determine a plurality of interpolation coordinate points based on interpolations of a plurality of coordinate point pairs in the first set of coordinate points. As an example, the calculation process of the plurality of interpolation coordinate points may be

$$q 1 = \frac{3 p 1 + p 2}{4}$$

$$q 2 = \frac{p 1 + 3 p 2}{4}$$

where p1 and p2 are a coordinate pair in the first set of coordinate points, and q1 and q2 are interpolation coordinate points obtained after interpolation.

The electronic device 110 may, for example, perform one or more rounds of interpolation processes to determine a smoothed second set of coordinate points.

Further, at 332, the electronic device 110 may calculate a triangulated face and a mesh based on the rendering data in the cache. At 334, the electronic device 110 may render a new graphical element based on the updated triangulated face and the mesh.

As a result, by performing rendering processes with different performances at different stages (e.g., during and after swiping), the embodiments of the present disclosure are able to not only reduce the performance consumption of the rendering, but also enhance the quality of the graphical elements created.

### Example Process

FIG. 4 illustrates a flowchart of an example process 400 of live streaming interaction according to some embodiments of the present disclosure. The process 400 may be implemented at terminal device 110. The process 400 is described below with reference to FIG. 1.

As shown in FIG. 4, in block 410, the electronic device 110 receives, in a live streaming interface of a live streaming room, a request for using an interactive resource.

In block 420, the electronic device 110 renders, in response to receiving a swipe operation, a first graphical element in the live streaming interface based on a first set of coordinate points corresponding to the swipe operation, the first graphical element including a plurality of map elements corresponding to the interactive resource;

At block 430, the electronic device 110 smooths, in response to ending of the swipe operation, the first set of coordinate points to determine a second set of coordinate points.

At block 440, the electronic device 110 renders a second graphical element in the live streaming interface based on the second set of coordinate points.

In some embodiments, the rendered first graphical element and the rendered second graphical element are provided to generate a live streaming image of the live streaming room.

In some embodiments, rendering the first graphical element in the live streaming interface based on the first set of coordinate points corresponding to the swipe operation includes: determining a set of texture coordinates corresponding to the first set of coordinate points; determining, based on a distance from a target texture coordinate in the set of texture coordinates to a reference texture coordinate, a target map element corresponding to the target texture coordinate from a set of predetermined map elements; and rendering the target map element in a mesh corresponding to the target texture coordinate.

In some embodiments, determining, based on the distance from the target texture coordinate in the set of texture coordinates to the reference texture coordinate, the target map element corresponding to the target texture coordinate from the set of predetermined map elements includes one of the following: determining a first map element from the set of predetermined map elements in response to the distance being less than a first threshold; determining a second map element from the set of predetermined map elements in response to the distance being greater than or equal to the first threshold and less than or equal to a second threshold; or determining a third map element from the set of predetermined map elements in response to the distance being greater than the second threshold.

In some embodiments, the first map element is a tail map; the second map element is a body map; or the third map element is a head map.

In some embodiments, the process 400 further includes: determining a target direction corresponding to the target texture coordinate; determining, based on the target direction, a plurality of extended coordinates associated with the target texture coordinate; and determining the mesh based on the plurality of extended coordinates.

In some embodiments, smoothing, in response to the ending of the swipe operation, the first set of coordinate points to determine the second set of coordinate points includes: determining a plurality of interpolation coordinate points based on interpolations of a plurality of coordinate point pairs in the first set of coordinate points; and determining the second set of coordinate points based on the plurality of interpolation coordinate points.

In some embodiments, the interactive resource is a first interactive resource, the plurality of map elements are a first set of map elements corresponding to the first interactive resource, the swipe operation is a first swipe operation, and the method further includes: receiving, in a live streaming interface of a live streaming room, a request for using a second interactive resource; and rendering, in response to receiving a second swipe operation, a third graphical element in the live streaming interface based on a third set of coordinate points corresponding to the second swipe operation, the third graphical element including a second set of map elements corresponding to the second interactive resource.

In some embodiments, the process 400 further includes: ceasing, in response to a selection of a first edit control associated with the interactive resource in the live streaming interface, to display the rendered second graphical element in the live streaming interface; or ceasing, in response to a selection of a second edit control associated with the interactive resource in the live streaming interface, to display in the live streaming interface a set of graphical elements rendered based on the interactive resource.

In some embodiments, the process 400 further includes: sending live streaming data to a server to display the live streaming image including the first graphical element or the second graphical element at a client associated with the live streaming room.

### Example Apparatus and Device

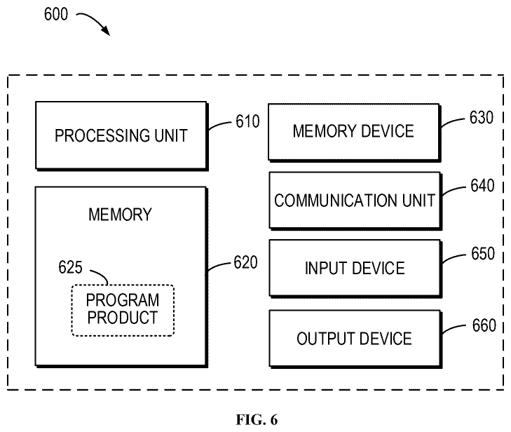

The embodiments of the present disclosure also provide a corresponding apparatus for implementing the above method or process. FIG. 5 illustrates a schematic structural block diagram of an apparatus 500 for live streaming interaction according to some embodiments of the present disclosure. The apparatus 500 may be implemented or included in the terminal device 110. The various modules/components in the apparatus 400 may be implemented by hardware, software, firmware, or any combination thereof.

As shown in FIG. 5, the apparatus 500 includes: a request receiving module 510 configured to receive, in a live streaming interface of a live streaming room, a request for using an interactive resource; a first rendering module 520 configured to render, in response to receiving a swipe operation, a first graphical element in the live streaming interface based on a first set of coordinate points corresponding to the swipe operation, the first graphical element including a plurality of map elements corresponding to the interactive resource; a coordinate smoothing module 530 configured to smooth, in response to ending of the swipe operation, the first set of coordinate points to determine a second set of coordinate points; and a second rendering module 540 configured to render a second graphical element in the live streaming interface based on the second set of coordinate points, where the rendered first graphical element and the rendered second graphical element are provided to generate a live streaming image of the live streaming room.

In some embodiments, the rendered first graphical element and the rendered second graphical element are provided to generate a live streaming image of the live streaming room.

In some embodiments, the first rendering module 520 is further configured to: determine a set of texture coordinates corresponding to the first set of coordinate points; determine, based on a distance from a target texture coordinate in the set of texture coordinates to a reference texture coordinate, a target map element corresponding to the target texture coordinate from a set of predetermined map elements; and render the target map element in a mesh corresponding to the target texture coordinate.

In some embodiments, the first rendering module 520 is further configured to: determine a first map element from the set of predetermined map elements in response to the distance being less than a first threshold; determine a second map element from the set of predetermined map elements in response to the distance being greater than or equal to the first threshold and less than or equal to a second threshold; or determine a third map element from the set of predetermined map elements in response to the distance being greater than the second threshold.

In some embodiments, the first map element is a tail map; the second map element is a body map; or the third map element is a head map.

In some embodiments, the first rendering module 520 is further configured to: determine a target direction corresponding to the target texture coordinate; determine, based on the target direction, a plurality of extended coordinates associated with the target texture coordinate; and determine the mesh based on the plurality of extended coordinates.

In some embodiments, the coordinate smoothing module 530 is further configured to: determine a plurality of interpolation coordinate points based on interpolations of a plurality of coordinate point pairs in the first set of coordinate points; and determine the second set of coordinate points based on the plurality of interpolation coordinate points.

In some embodiments, the interactive resource is a first interactive resource, the plurality of map elements are a first set of map elements corresponding to the first interactive resource, the swipe operation is a first swipe operation, and the apparatus 500 further includes an interaction module configured to: receive, in a live streaming interface of a live streaming room, a request for using a second interactive resource; and render, in response to receiving a second swipe operation, a third graphical element in the live streaming interface based on a third set of coordinate points corresponding to the second swipe operation, the third graphical element including a second set of map elements corresponding to the second interactive resource

In some embodiments, the process 500 further includes a drawing controlling module configured to: cease, in response to a selection of a first edit control associated with the interactive resource in the live streaming interface, to display the rendered second graphical element in the live streaming interface; or cease, in response to a selection of a second edit control associated with the interactive resource in the live streaming interface, to display in the live streaming interface a set of graphical elements rendered based on the interactive resource.

In some embodiments, the apparatus 500 further includes a sending module configured to send live streaming data to a server to display the live streaming image including the first graphical element or the second graphical element at a client associated with the live streaming room.

The units included in the apparatus 500 may be implemented in various manners, including software, hardware, firmware, or any combination thereof. In some embodiments, one or more units may be implemented using software and/or firmware, such as machine-executable instructions stored on a storage medium. In addition to or as an alternative to machine-executable instructions, some or all of the units in the apparatus 500 may be implemented, at least in part, by one or more hardware logic components. By way of example and not limitation, example types of hardware logic components that may be used include field programmable gate arrays (FPGAs), application specific integrated circuits (ASICs), application-specific standard products (ASSPs), systems-on-chip (SOCs), complex programmable logic devices (CPLDs), and the like.

FIG. 6 illustrates a block diagram of an electronic device 600 in which one or more embodiments of the present disclosure may be implemented. It would be appreciated that the electronic device 600 illustrated in FIG. 6 is merely example and should not constitute any limitation on the functionality and scope of the embodiments described herein. The electronic device 600 shown in FIG. 6 may be configured to implement the electronic device 110 in FIG. 1.

As shown in FIG. 6, the electronic device 600 is in the form of a general-purpose electronic device. Components of the electronic device 600 may include, but are not limited to, one or more processors or processing units 610, a memory 620, a storage device 630, one or more communication units 640, one or more input devices 650, and one or more output devices 660. The processing unit 610 may be an actual or virtual processor and capable of performing various processes according to programs stored in the memory 620. In multiprocessor systems, a plurality of processing units execute computer-executable instructions in parallel to improve parallel processing capabilities of the electronic device 600.

The electronic device 600 typically includes a plurality of computer storage media. Such media may be any available media accessible to the electronic device 600, including, but not limited to, volatile and non-volatile media, removable and non-removable media. The memory 620 may be volatile memory (e.g., registers, caches, random access memory (RAM)), non-volatile memory (e.g., read-only memory (ROM), electrically erasable programmable read-only memory (EEPROM), flash memory), or some combination thereof. The storage device 630 may be a removable or non-removable medium and may include a machine-readable medium, such as a flash drive, magnetic disk, or any other medium, which may be capable of storing information and/or data and may be accessed within the electronic device 600.

The electronic device 600 may further include additional removable/non-removable, volatile/non-volatile storage media. Although not shown in FIG. 6, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 620 may include a computer program product 626 having one or more program modules configured to perform various methods or actions of various embodiments of the present disclosure.

The communication unit 640 is configured to communicate with a further electronic device through a communication medium. Additionally, the functionality of components of the electronic device 600 may be implemented in a single computing cluster or multiple computing machines capable of communicating over a communication connection. Thus, the electronic device 600 may operate in a networked environment using logical connections with one or more other servers, network personal computers (PCs), or a further network node.

The input device 650 may be one or more input devices, such as a mouse, a keyboard, a trackball, or the like. The output device 660 may be one or more output devices, such as a display, a speaker, a printer, or the like. The electronic device 600 may also communicate with one or more external devices (not shown) through the communication unit 640 as needed, external devices such as storage devices, display devices, etc., communicate with one or more devices that enable a user to interact with the electronic device 600, or communicate with any device (e.g., a network card, a modem, etc.) that enables the electronic device 600 to communicate with one or more other electronic devices. Such communication may be performed via an input/output (I/O) interface (not shown).

According to example implementations of the present disclosure, a computer-readable storage medium having computer-executable instructions stored thereon is provided, the computer program, when executed by a processor, implementing the method of described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It would be appreciated that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram (s).

The computer-readable program instructions may be loaded onto a computer, other programmable data processing apparatus, or other device, such that a series of operational steps are performed on a computer, other programmable data processing apparatus, or other device to produce a computer-implemented process such that the instructions executed on a computer, other programmable data processing apparatus, or other device implement the functions/acts specified in the flowchart and/or block diagram block or blocks.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are example, not exhaustive, and are not limited to the implementations disclosed. Many modifications and variations would be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

What is claimed is:

1. A method of live streaming interaction, comprising:
receiving, in a live streaming interface of a live streaming room, a request for using an interactive resource;
rendering, in response to receiving a swipe operation, a first graphical element in the live streaming interface based on a first set of coordinate points corresponding to the swipe operation, the first graphical element comprising a plurality of map elements corresponding to the interactive resource;
smoothing, in response to ending of the swipe operation, the first set of coordinate points to determine a second set of coordinate points; and
rendering a second graphical element in the live streaming interface based on the second set of coordinate points,
wherein the rendered first graphical element and the rendered second graphical element are provided to generate a live streaming image of the live streaming room.

2. The method of claim 1, wherein rendering the first graphical element in the live streaming interface based on the first set of coordinate points corresponding to the swipe operation comprises:
determining a set of texture coordinates corresponding to the first set of coordinate points;
determining, based on a distance from a target texture coordinate in the set of texture coordinates to a reference texture coordinate, a target map element corresponding to the target texture coordinate from a set of predetermined map elements; and
rendering the target map element in a mesh corresponding to the target texture coordinate.

3. The method of claim 2, wherein determining, based on the distance from the target texture coordinate in the set of texture coordinates to the reference texture coordinate, the target map element corresponding to the target texture coordinate from the set of predetermined map elements comprises one of the following:
determining a first map element from the set of predetermined map elements in response to the distance being less than a first threshold;
determining a second map element from the set of predetermined map elements in response to the distance being greater than or equal to the first threshold and less than or equal to a second threshold; or
determining a third map element from the set of predetermined map elements in response to the distance being greater than the second threshold.

4. The method of claim 3, wherein:
the first map element is a tail map;
the second map element is a body map; or
the third map element is a head map.

5. The method of claim 2, further comprising:
determining a target direction corresponding to the target texture coordinate;
determining, based on the target direction, a plurality of extended coordinates associated with the target texture coordinate; and
determining the mesh based on the plurality of extended coordinates.

6. The method of claim 1, wherein smoothing, in response to the ending of the swipe operation, the first set of coordinate points to determine the second set of coordinate points comprises:
determining a plurality of interpolation coordinate points based on interpolations of a plurality of coordinate point pairs in the first set of coordinate points; and
determining the second set of coordinate points based on the plurality of interpolation coordinate points.

7. The method of claim 1, wherein the interactive resource is a first interactive resource, the plurality of map elements are a first set of map elements corresponding to the first interactive resource, the swipe operation is a first swipe operation, and the method further comprises:
receiving, in the live streaming interface of the live streaming room, a request for using a second interactive resource; and
rendering, in response to receiving a second swipe operation, a third graphical element in the live streaming interface based on a third set of coordinate points corresponding to the second swipe operation, the third graphical element comprising a second set of map elements corresponding to the second interactive resource.

8. The method of claim 1, further comprising:
ceasing, in response to a selection of a first edit control associated with the interactive resource in the live streaming interface, to display the rendered second graphical element in the live streaming interface; or
ceasing, in response to a selection of a second edit control associated with the interactive resource in the live streaming interface, to display in the live streaming interface a set of graphical elements rendered based on the interactive resource.

9. The method of claim 1, further comprising:
sending live streaming data to a server to display the live streaming image comprising the first graphical element or the second graphical element at a client associated with the live streaming room.

10. An electronic device comprising:
at least one processor; and
at least one memory coupled to the at least one processor and storing instructions for execution by the at least one processor, the instructions, when executed by the at least one processor, causing the electronic device to perform operations comprising:
receiving, in a live streaming interface of a live streaming room, a request for using an interactive resource;
rendering, in response to receiving a swipe operation, a first graphical element in the live streaming interface based on a first set of coordinate points corresponding to the swipe operation, the first graphical element comprising a plurality of map elements corresponding to the interactive resource;
smoothing, in response to ending of the swipe operation, the first set of coordinate points to determine a second set of coordinate points; and
rendering a second graphical element in the live streaming interface based on the second set of coordinate points,
wherein the rendered first graphical element and the rendered second graphical element are provided to generate a live streaming image of the live streaming room.

11. The electronic device of claim 10, wherein rendering the first graphical element in the live streaming interface based on the first set of coordinate points corresponding to the swipe operation comprises:
determining a set of texture coordinates corresponding to the first set of coordinate points;
determining, based on a distance from a target texture coordinate in the set of texture coordinates to a reference texture coordinate, a target map element corresponding to the target texture coordinate from a set of predetermined map elements; and
rendering the target map element in a mesh corresponding to the target texture coordinate.

12. The electronic device of claim 11, wherein determining, based on the distance from the target texture coordinate in the set of texture coordinates to the reference texture coordinate, the target map element corresponding to the target texture coordinate from the set of predetermined map elements comprises one of the following:
determining a first map element from the set of predetermined map elements in response to the distance being less than a first threshold;
determining a second map element from the set of predetermined map elements in response to the distance being greater than or equal to the first threshold and less than or equal to a second threshold; or
determining a third map element from the set of predetermined map elements in response to the distance being greater than the second threshold.

13. The electronic device of claim 12, wherein:
the first map element is a tail map;
the second map element is a body map; or
the third map element is a head map.

14. The electronic device of claim 11, wherein the operations further comprise:
determining a target direction corresponding to the target texture coordinate;
determining, based on the target direction, a plurality of extended coordinates associated with the target texture coordinate; and
determining the mesh based on the plurality of extended coordinates.

15. The electronic device of claim 10, wherein smoothing, in response to the ending of the swipe operation, the first set of coordinate points to determine the second set of coordinate points comprises:
determining a plurality of interpolation coordinate points based on interpolations of a plurality of coordinate point pairs in the first set of coordinate points; and
determining the second set of coordinate points based on the plurality of interpolation coordinate points.

16. The electronic device of claim 10, wherein the interactive resource is a first interactive resource, the plurality of map elements are a first set of map elements corresponding to the first interactive resource, the swipe operation is a first swipe operation, and the operations further comprise:
receiving, in the live streaming interface of the live streaming room, a request for using a second interactive resource; and
rendering, in response to receiving a second swipe operation, a third graphical element in the live streaming interface based on a third set of coordinate points corresponding to the second swipe operation, the third graphical element comprising a second set of map elements corresponding to the second interactive resource.

17. The electronic device of claim 10, wherein the operations further comprise:
ceasing, in response to a selection of a first edit control associated with the interactive resource in the live streaming interface, to display the rendered second graphical element in the live streaming interface; or
ceasing, in response to a selection of a second edit control associated with the interactive resource in the live streaming interface, to display in the live streaming interface a set of graphical elements rendered based on the interactive resource.

18. The electronic device of claim 10, wherein the operations further comprise:
sending live streaming data to a server to display the live streaming image comprising the first graphical element or the second graphical element at a client associated with the live streaming room.

19. A non-transitory computer-readable storage medium having a computer program stored thereon, the computer program, when executed by a processor, implementing perform operations comprising:
receiving, in a live streaming interface of a live streaming room, a request for using an interactive resource;
rendering, in response to receiving a swipe operation, a first graphical element in the live streaming interface based on a first set of coordinate points corresponding to the swipe operation, the first graphical element comprising a plurality of map elements corresponding to the interactive resource;
smoothing, in response to ending of the swipe operation, the first set of coordinate points to determine a second set of coordinate points; and
rendering a second graphical element in the live streaming interface based on the second set of coordinate points,
wherein the rendered first graphical element and the rendered second graphical element are provided to generate a live streaming image of the live streaming room.

20. The non-transitory computer-readable storage medium of claim 19, wherein rendering the first graphical element in the live streaming interface based on the first set of coordinate points corresponding to the swipe operation comprises:
determining a set of texture coordinates corresponding to the first set of coordinate points;
determining, based on a distance from a target texture coordinate in the set of texture coordinates to a reference texture coordinate, a target map element corresponding to the target texture coordinate from a set of predetermined map elements; and
rendering the target map element in a mesh corresponding to the target texture coordinate.
